(19) United States
(12) Patent Application Publication
(10) Pub. No.: US 2006/0143630 A1
(43) Pub. Date: Jun. 29, 2006

(54) Disc transfer apparatus

(75) Inventors: Takashi Yamanaka, Tokyo (JP); Toshio Yoshimura, Kanagawa-ken (JP); Akeshi Shitamichi, Tokyo (JP); Eiji Shinohara, Kanagawa-ken (JP)

Correspondence Address: BACON & THOMAS, PLLC, 625 SLATERS LANE, FOURTH FLOOR, ALEXANDRIA, VA, 22314, US

(73) Assignee: Tanashin Denki Co., Ltd., Tokyo (JP)

(21) Appl. No.: 11/318,613

(22) Filed: Dec. 28, 2005

(30) Foreign Application Priority Data
Dec. 28, 2004 (JP) 2004-378742

(51) Int. Cl. G11B 17/04

(52) U.S. Cl. 720/619

(57) ABSTRACT

The present invention seeks to provide a disc transfer apparatus, which permits increasing the disc kick-off extent while holding a constant distance between a transfer roller and a turntable. A disc transfer apparatus is disclosed, which can choose either one of a play-back base fixing mode, in which a transfer roller is held at a disc transfer position while restricting motion of the play-back base relative to a housing, thereby permitting loading/unloading of disc, and a play-back base release mode, in which the transfer roller is held at a non-disc transfer position while holding the play-back base in a floating state relative to the housing. At the time of switching the play-back base release mode over to the play-back base fixing mode, a movable number, which is mounted on the play-back base such as to have bearing on the choice of either one of the play-back base release and fixing modes, is brought into contact with part of the housing, thus permitting the play-back base to approach a disc in-outlet slot against buffering force of the buffer member.

### BACKGROUND OF THE INVENTION

1. Field of the Invention

This invention relates to a disc transfer apparatus, which permits ensuring sufficient disc kick-off extent.

2. Description of the Prior Art

In a slot-in type disc transfer apparatus, in which a disc is inserted directly into it from a disc in-outlet slot, when playing back a disc, usually a play-back unit is held in a floating state in a housing, while when transferring the disc the play-back unit is held stationary relative to the housing.

The play-back unit is held stationary relative to the housing when transferring the disc in order to preclude erroneous loading and unloading of the disc and also damage inflicted thereto. Hitherto, various means for holding the play-back unit stationary when transferring a disc has been proposed, as being described in Japanese patent disclosure No. 2003-317355.

FIGS. 5(a) and (b) are side views showing a prior art disc transfer apparatus.

FIG. 5(a) shows the apparatus in a state of playing back a disc. Reference numerals 101 and 102 in the Figure designate a top and a bottom, respectively, of a housing 103. A play-back base 105 is supported in a floating state through a buffer member 104 in the housing 103. The play-back base 105 has a turntable 106, a clamper 107, a pick-up (not shown), etc. A disc D1 is clamped between the turntable 106 and the clamper 107.

Leftward of the play-back base 105 in the Figure, a roller support 109 supporting a transfer roller 108 for rotation thereof is mounted for rocking movement about its mounting site 110. Displacement of a reciprocal member 111 mounted on the play-back base 105 to the left and right in the Figure, can cause rocking movement of the roller support 109.

FIG. 5(b) shows the apparatus in a state of transfer in the disc. The disc D1 is loaded and unloaded through a disc in-outlet slot 112. When kicking off the disc, the reciprocal member 111 is displaced to the right in the Figure, whereby protuberances 113 and 114 as parts of the roller support 109 are engaged in engagement holes 115 and 116 formed in the top 101 and the bottom 102, respectively, of the housing 103. With this engagement, the play-back base 105 is held restricted against displacement relative to the housing 103.

In this disc transfer apparatus, however, the transfer roller is considerably spaced apart from the disc in-outlet slot. Therefore, when kicking off the disc, the disc is kicked off only to a small extent. The kick-off extent of the disc may be increased by disposing the transfer roller close to the disc in-outlet slot. By so doing, however, the transfer roller and the turntable are spaced apart too much, thus giving rise to the possibility that a small-size disc can not be transferred up to the turntable. Also, disposing the in-outlet slot to be closer to the transfer roller for increasing the disc kick-off extent, may result in too close disposition of the in-outlet slot to the turntable, and it is thus possible that a large-size disc being played back partly extends out of the in-outlet slot.

The present invention seeks to solve the above problems, and its object is to provide a disc transfer apparatus, which is simple in arrangement and ensures sufficient disc kick-off extent when kicking off the disc without changing the distance between the transfer roller and the turntable.

### SUMMARY OF THE INVENTION

In the disc transfer apparatus according to the invention, at the time of switching of a play-back base release mode over to a play-back base fixing mode, a movable member supported in a play-back base to be reciprocally moved to have bearing on the choice of either of the play-back base release and fixing modes, is further moved with the state being into contact with part of a housing thereby to permit approach of the disc in-outlet slot by the play-back base against the buffering force of a buffer member.

Suitably, the reciprocal member for causing rocking movement of roller support is adapted to serve as movable member as well, so that at the time of switching of the play-back base release mode over to the play-back base fixing mode, the reciprocal member is brought into contact with part of the housing to permit approach of the disc in-outlet slot by the play-back base against the buffering force of the buffer member.

Also suitably, the roller support is adapted to serve as movable member as well, so that at the time of switching of the play-back base release mode over to the play-back base fixing mode, the roller support is brought into contact with part of the housing to permit approach of the disc in-outlet slot by the play-back base against the buffering force of the buffer member.

With the disc transfer apparatus according to the invention, since at the time of switching of the play-back base release mode over to the play-back base fixing mode, the movable member is brought into contact with part of the housing to permit approach of the disc in-outlet slot by the play-back base against the buffering force, it is possible to cause disc kick-off in a state that the disc in-outlet slot has been approached by the disc in-outlet slot. Thus, the disc kick-off extent can be increased to permit ready pull-out removal of the disc.

Also, since the play-back base itself can be caused to approach the disc in-outlet slot, a small-size disc can be transferred up to the turntable without any problem without change in the distance between the transfer roller and the turntable. Besides, in the play-back base release mode, the play-back base is restored to its initial position by the buffering force of the buffer member, and the distance between the disc in-outlet slot and the turntable is not changed, thus it is possible to ensure that a large-size disc is played back without extension of its edge out of the disc in-outlet slot.

Furthermore, since the movable member is an existing part which is mounted on the play-back base and having bearing on the choice of either of the play-back base release and fixing modes, it is possible to increase the disc kick-off extent without adding any new part.

Moreover, the reciprocal member or the roller support can be adapted to serve as movable member as well.

### BRIEF DESCRIPTION OF THE DRAWINGS

The invention will become more apparent upon a reading of the following detailed description with reference to the accompanying drawings, in which:

FIG. 1 is a perspective view showing the outer view of an embodiment of disc transfer apparatus;

FIG. 2 is a side view showing part of the disc transfer apparatus;

FIGS. 3(a) to 3(d) are side views for describing the operation of the embodiment at the time of disc kick-off;

FIGS. 4(a) and 4(b) are fragmentary side views illustrating the behavior of the roller support as movable member in a different embodiment; and

FIGS. 5(a) and 5(b) are side views illustrating the behavior of a prior art apparatus at a disc loading time.

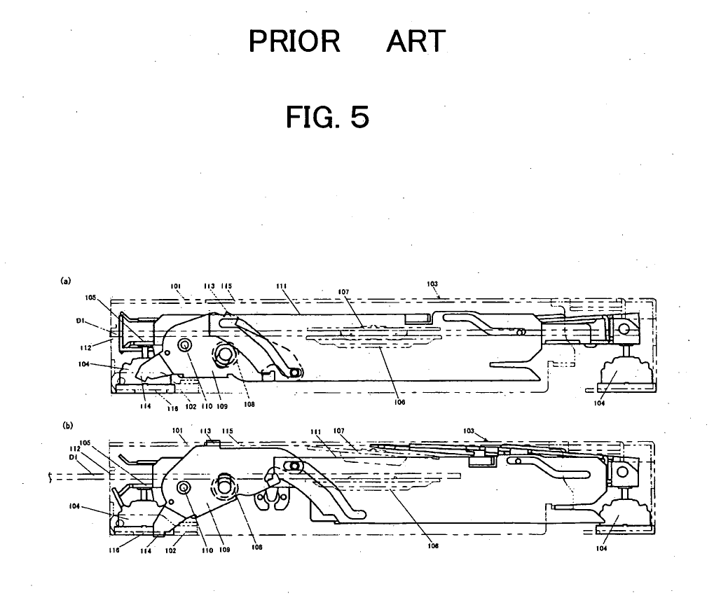

### DESCRIPTION OF THE PREFERRED EMBODIMENTS

Now, the best embodiment of the invention will be described with reference to the drawings.

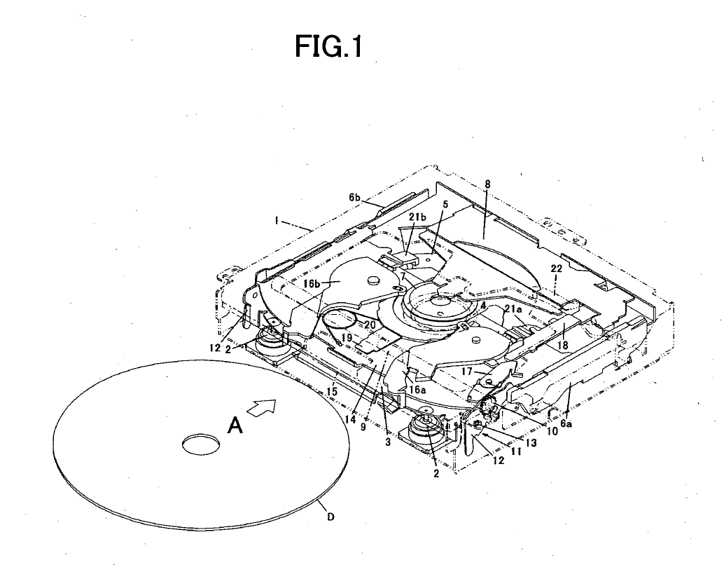

FIG. 1 is a perspective view showing the internal arrangement of a car-mounted disc transfer apparatus. An outer housing 1 is shown by imaginary lines. A disc D1 is inserted into the housing 1 from the front side thereof in the direction of arrow A.

In the housing 1, a play-back base 3 is supported in a floating state by buffer members 2. The play-back base 3 carries a turntable 4 (shown by imaginary lines) mounted at its center, and also it carries a pick-up 5 mounted movably and directed toward one of its corners.

The play-back base 3 has a left and a right side wall, in which reciprocal members 6a and 6b, respectively, are mounted as movable member made of plastic material for back-and-forth displacement.

Above the turntable 4, a clamper 7 is disposed, which is supported for rocking movement by a clamper support 8 formed from a metal sheet. The clamper support 8 can be driven by the reciprocal member 6a to cause rocking movement of the clamper 7 toward and away from the turntable 4.

In a front part of the housing 1, a transfer roller 9 (shown by imaginary lines) is disposed for transferring a disc D. The transfer roller 9 has a gear 10 mounted at its one end and also has a collar(not shown) mounted at its other end, and its both ends are supported for rotation in roller supports 11. The roller supports are mounted for rocking movement in the left and right side walls, respectively, of the play-back base 3.

The roller support 11 has a left and a right side wall parts 12, respectively, which each have a hole 13. The roller support 11 has the holes 13 fitted for rocking movement on the left and right side walls, respectively, of the play-back base 3, and the rocking movement of the roller support 11 causes displacement of the transfer roller 9 between a disc transfer position and a non-disc transfer position.

Above the play-back base 3, a guide plate 14 formed from a metal sheet is disposed. The guide plate 14 cooperates with the transfer roller 9 to clamp the disc D and transfer the same with rotation of the transfer roller 9. The housing 1 has a disc in-outlet slot 15 provided at its front. The disc D is inserted through the disc in-outlet slot 15 into a space between the guide plate 14 and the transfer roller 9.

Mounted atop the guide plate 14 are a pair of (i.e., left and right) sensor levers 16a and 16b capable of being horizontally rocked, a lock lever 17 for locking the sensor levers 16a and 16b at its open position when a large-size disc has been inserted, a movable plate 18 for advancing and retreating with rocking movement of the sensor levers 16a and 16b, an interlock member 19 for synchronizing the motion of the sensor levers 16a and 16b, and a torsion spring 20 biasing the two sensor levers 16a and 16b toward the respective closed positions thereof.

The sensor levers 16a and 16b have stopper parts 21a and 21b, respectively, which can be brought into contact with the edge of a mall-size disc during transfer thereof. A trigger lever 22 (shown by imaginary lines) is coupled to a rear part of the movable plate 18 such as to start and stop a disc transfer mechanism (not shown). This disc transfer mechanism is mounted on the play-back base 3.

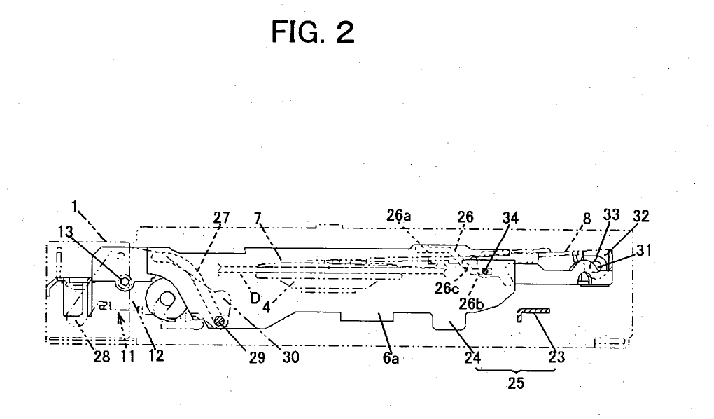

FIG. 2 is a side view showing a right side part of the disc transfer apparatus in a state that a disc D is clamped between the turntable 4 and the damper 7.

As shown in FIG. 2, the housing 1 (shown by imaginary lines) has a part serving as a contactable piece 23. The cross section of the contactable piece 23 has a shape having a downwardly bent end part. The reciprocal member 6a has a contact piece 24 downwardly projecting from its rightward lower part in the Figure. The contact piece 24 of the reciprocal member 6a and the contactable piece 23 of the housing 1 constitute a play-back base displacing means 25. Above the contact piece 24 are formed a cam groove 26 (shown by broken lines) and another cam groove 27 in the leftward part in the Figure. The cam groove 26 has an upper part 26a, a lower part 26b, both parts extending horizontally, and a slant part 26c connecting the upper and lower parts 26a and 26b. The leftward cam groove 27 has a rightward and downward slant shape in the Figure.

Each of the left and right side walls 12 (here the right side wall) of the roller support 11 has an extension piece 28 extending downward from the site of the rocking center hole 13, and also has an engagement protuberance 29 formed at the free end of a rearward (rightward in the Figure) extended portion. The side wall further has a raised part 30 formed above the engagement protuberance 29. The engagement protuberance 29 is engaged in the cam groove 27 formed in the reciprocal member 6a.

The damper support 8 noted above is disposed in a rear part (rightward in the Figure) of the disc transfer apparatus. The damper support 8 has a rear curved part 32 having an axis 31 as center of rocking movement. The rocking center axis 31 is fitted for rocking movement in a mounting hole 33 formed in the play-back base 3.

The damper support 8 has a central protuberance 34, which is formed in substantially the center thereof along the longitudinal direction and is engaged in the cam groove 26 formed in the reciprocal member 6a.

Although FIG. 2 describes only the right side of the disc transfer apparatus shown in FIG. 1, the left side of the apparatus likewise has the reciprocal member 6b (including contact piece 24 and cam groove 27). Also, the left side wall 12 of the roller support 11 has the engagement protuberance 29 engaged in left side cam groove 27. Furthermore, the left side of the housing 1 has the contactable piece 23.

The operation of the embodiment of the apparatus will now be described.

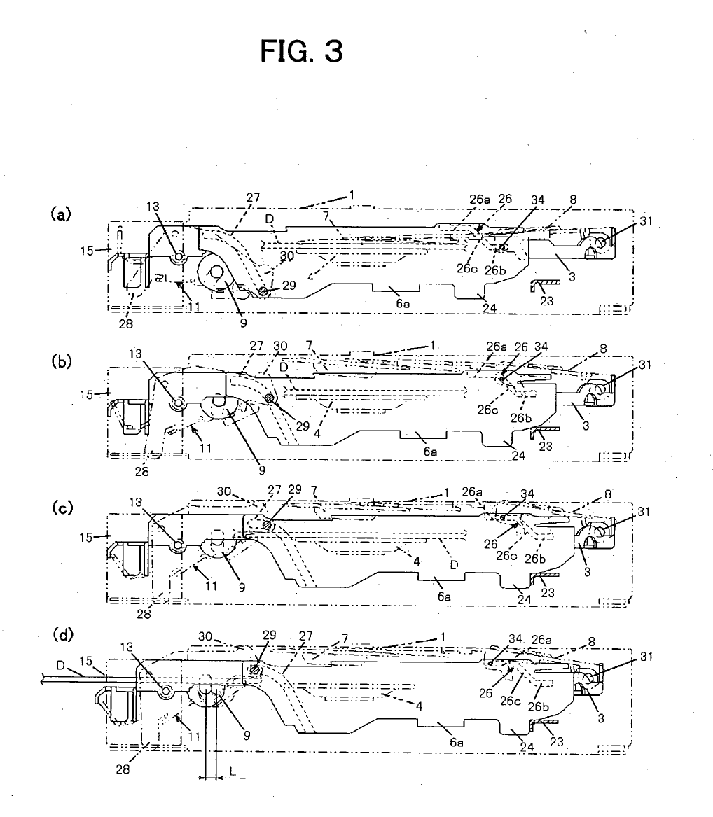

FIG. 3(a) shows the apparatus in a play-back base release mode, in which disc D is clamped between the turntable 4 and the damper 4. In this state, the play-back member 3 is held in a floating state by the buffer members 2 shown in FIG. 1. The reciprocal member 6a is located at substantially the center of the housing 1 in the disc loading/unloading directions by the disc transfer mechanism (not shown). The engagement protuberance 29 of the roller support 11 is located at lower end of the cam groove 27 in the Figure. The transfer roller 9 is located in the non-disc transfer position and spaced apart from the disc D. The protuberance 34 of the damper support 8 is located in the lower part 26b of the cam groove 26.

When the disc kick-off operation is began in this state, the disc transfer mechanism (not shown) provided on the play-back base 3 is started and, as shown in FIG. 3(b), the reciprocal member 6a starts to be displaced in a direction opposite to the direction toward (i.e., rightward of, in the Figure) the disc in-outlet slot 15. The displacement of the reciprocal member 6a causes upward displacement, along the cam groove 27, of the engagement protuberance 29 of the roller support 11 engaged in the cam groove 27. The roller support 11 is thus rocked counterclockwise about the hole 11. Also, the protuberance 34 of the damper support 8 engaged in the cam groove 26 is displaced from the lower part 26 to the slant part 26c of the cam groove 26, thus causing counterclockwise rocking movement of the damper support 8 about the rocking center axis 31. With this rocking movement, the disc D is separated from the damper 7.

Furthermore, with the rightward displacement in the Figure of the reciprocal member 6a, as shown in FIG. 3(c), the contact piece 24 of the reciprocal member 6a is brought into contact with the contactable piece 23 of the housing 1. At this time, the engagement protuberance 29 of the damper support 11 has been further displaced upward along the can groove 27. Also, the protuberance 34 of the damper support 8 has reached the upper part 26a of the am groove 26.

When the reciprocal member 6a is further displaced rightward in the Figure toward the play-back base 3 in the state that the contact piece 24 of the reciprocal member 6a has been in contact with the contactable member 23, the play-back base 3 approaches the disc in-outlet slot 15 against the buffering force of the buffer member 2 owing to the contact of the contact and contactable pieces 24 and 23 with each other.

When the engagement protuberance 29 of the roller support 11 is displaced upward up to the upper end of the cam groove 27, the roller support 11 is continually rocked counterclockwise about the hole 13 to eventually bring about the state in play-back base fixing mode as shown in FIG. 3(d). In this state, the free end of the extension piece 28 is in contact with the bottom of the housing 1, and the raised part 30 is in contact with the top of the housing 1. Thus, the play-back base 3 is restricted against vertical displacement relative to the housing 1. Also, the transfer roller 9 has been brought to its transfer position by the rocking movement of the roller support 11, so that the disc D is clamped between the guide plate 14 described before in connection with FIG. 1 and the transfer roller 9. In this state, the disc D can be transferred by counterclockwise rotation in the Figure of the transfer roller 9.

When the play-back base fixing mode is switched over to the play-back base release mode again, the play-back base 3 is restored to its initial position by the buffering force of the buffer member 2.

As shown above, in the play-back base fixing mode shown in FIG. 3(d), the play-back base 3 is brought to be closer to the disc in-outlet slot 15 than in the case of the play-back base release mode shown in FIG. 3(a) to 3(c). Thus, the disc can be licked off in the state that the transfer roller 9 is closer to the disc in-outlet slot 15 to an extent corresponding to dimension L in the Figure. Also, since the play-back base 3 itself is brought to be closer to the disc in-outlet slot 15, the distance between the transfer roller 9 and the turntable 4 is not changed. Thus, a small-size disc inserted can be transferred up to the turntable 4 without any problem. Of course, since the disc in-outlet slot 15 is not bought to be closer to the turntable 4, a large-size disc can be played back without its partial extension out of the disc in-outlet slot 15.

The embodiment of the invention having been described above, is by no means limitable; for instance, while in the above embodiment the reciprocal members 6a and 6b have been used as movable member as well, the movable member is not limited to the reciprocal members, and it is possible to use any member, which can be mounted on the play-back base and such as to bear on the choice of either of the play-back base release and fixing modes.

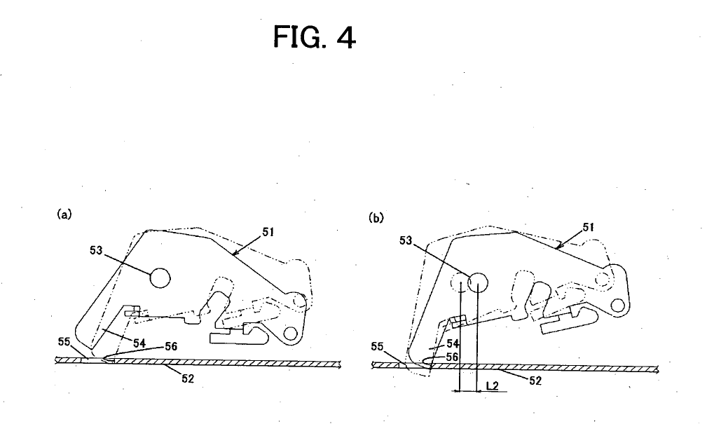

A different embodiment, in which a roller support 51 serves as movable member as well, will now be described with reference to FIGS. 4(a) and 4(b). In the different embodiment shown in FIGS. 4(a) and 4(b), parts which are the same in shape, function, etc. as those in the above embodiments are not described.

FIGS. 4(a) and 4(b) show the relation between the roller support 51 as movable member and housing 52 at the time of switching from the floating over to the play-back base fixing mode.

In the play-back base release mode, each (i.e., here right side) roller support 51 is at the position shown by solid lines in FIG. 4(a). By causing the disc kick-off operation, the reciprocal member starts to be displayed toward the disc inserting direction, causing counterclockwise rotation in the Figure of the roller support 51 about rocking center axis 53. The roller support 51 has extension piece 54, which is longer in size than the extension piece 28 in the previous embodiment. With rocking movement of the roller support 51, the extension piece 54 is thus inserted in slot 55 formed in part of housing 52, as shown by imaginary lines in FIG. 4(a).

With further rocking movement of the roller support 51, as shown by solid lines in FIG. 4(b), the extension piece 54 is brought into contact with the end 56 of the slot 55. Then, as the extension piece 54 pushes the end 56 of the slot 55, the rocking center axis 53 is displaced (a distance L2) toward the disc in-outlet slot, as shown by imaginary lines in FIG. 4(b). At the time of switching over to the play-back base fixing mode, like the previous embodiment, the play-back base can be caused to approach the disc in-outlet slot.

As has been shown, at the time of switching the play-back base release mode over to the play-back base fixing mode, the play-back base can be cased, by utilizing the movement of the roller support 51, to approach the disc in-outlet slot. It is thus possible to obtain the same effects as in the previous embodiment.

What is claimed is:

1. A disc transfer apparatus comprising:
a housing (1) having a disc in-outlet slot(15) for inserting a disc;
a play-back base (3) carrying a turntable (4) and a pick-up (5) and supported in a floating state in said housing through a buffer member (2);
a roller support (1) supported to be rocked on said play-back base;
a transfer roller (9) supported by said roller support at both ends thereof for rotation and displaced between a disc transfer position and a non-disc transfer position, said transfer roller being rotated at said disc transfer position thereby to transfer the disc, and
a movable member (6a, 6b, 51) supported in said play-back base to be reciprocally moved to have bearing on the choice of a play-back base fixing mode and a play-back base release mode,
wherein said disc transfer apparatus can be selectively set up in either one of the play-back base fixing mode, in which said transfer roller is held at said disc transfer position while restricting movement of said play-back base relative to said housing, thereby permitting loading/unloading of the disc, and the play-back base release mode, in which said transfer roller is held at said non-disc transfer position while holding said play-back base in a floating state relative to said housing; and at the time of switching of said play-back base release mode over to said play-back base fixing mode, said movable member is moved in a state being contact with part of said housing, thereby to move further said play back base against said buffering member to permit said transfer roller to approach said disc in-outlet slot.

2. The disc transfer apparatus according to claim 1, wherein said movable member is a reciprocal member which is supported on said play-back base for reciprocal movement, said reciprocal member serving to rock said roller support by the reciprocal movement thereof thereby to selectively position said transfer roller to either one of said disc transfer position and non-disc transfer position.

3. The disc transfer apparatus according to claim 1, wherein said roller support can serve as said movable member as well.
